(19) United States
(12) Patent Application Publication
(10) Pub. No.: US 2011/0069263 A1
(43) Pub. Date: Mar. 24, 2011

(54) Liquid crystal display apparatus

(76) Inventor: Shintaro Takeda, Hitachi (JP)

(21) Appl. No.: 12/805,844

(22) Filed: Aug. 20, 2010

(30) Foreign Application Priority Data
Sep. 18, 2009 (JP) 2009-217827

(51) Int. Cl. G02F 1/1333

(52) U.S. Cl. 349/122

(57) ABSTRACT

Provided is a liquid crystal display apparatus including: a pair of substrates (SUB1 and SUB2); a medium (LC) which is sandwiched between the pair of substrates, is optically isotropic when no voltage is applied thereto, and exhibits optical anisotropy when a voltage is applied thereto; a pixel electrode (PX) and a common electrode (CT) which are formed on one of the pair of substrates , at least one of the pixel electrode and the common electrode being formed into a comb tooth shape; and a horizontal orientation film (AL) which is subjected to orientation treatment so as to orient the medium in a direction horizontal to the pair of substrates , and is formed on an interface of at least one of the pair of substrates with the medium, in which the medium has a selective reflection peak derived from a (110) plane at 400 nm or less.

### CROSS-REFERENCE TO RELATED APPLICATION

The present application claims priority from Japanese application JP2009-217827 filed on Sep. 18, 2009, the content of which is hereby incorporated by reference into this application.

### BACKGROUND OF THE INVENTION

1. Field of the Invention

The present invention relates to a liquid crystal display apparatus that uses a medium exhibiting optical isotropy when no voltage is applied thereto.

2. Description of the Related Art

Owing to the progress in the manufacturing technology of the liquid crystal panel in recent years, a liquid crystal display apparatus is gaining popularity as a display for a television set, of which mainstream has heretofore been a cathode-ray tube. For example, the in-plane switching (lateral electric field) display mode (hereinafter, referred to as the IPS mode) and the vertical alignment display mode (hereinafter, referred to as the VA mode) are known as modes for improving a contrast and viewing angle characteristics of a liquid crystal display element. These modes enable the viewing angle and the contrast to be improved to a greater extent than the twisted nematic (TN) mode.

However, in the IPS and VA modes, a liquid crystal layer is an optically uniaxial medium, and accordingly, transmittance thereof depends on the viewing angle. Further, as described in “Physical Properties of Liquid Crystalline Materials”, pp. 90-94, written by W. H. de Jeu, translated by ISHII Chikara and KOBAYASHI Shunsuke, a nematic liquid crystal material exhibits light scattering resulting from thermal fluctuation of molecules thereof. Transmittance in black display is increased owing to this light scattering, and accordingly, lowering of the contrast is theoretically inevitable in IPS and VA liquid crystal display apparatuses according to the normally black mode of displaying black when no voltage is applied thereto. Such problems as the optical anisotropy and the light scattering are problems intrinsic to the liquid crystal display apparatus using the nematic liquid crystal material. Meanwhile, these liquid crystal display apparatuses have a problem of being inferior to the cathode-ray tube in moving picture quality. It is known that such inferiority is caused by slowness of an electro-optical response of the above-mentioned nematic liquid crystal material for use in the liquid crystal display apparatuses, and it is desired that a nematic liquid crystal material capable of the electro-optical response at high speed be developed.

As a display mode that solves the above-mentioned problems, in recent years, a display mode has been proposed, which uses liquid crystal having optical isotropy (hereinafter, referred to as isotropic liquid crystal or optically isotropic liquid crystal) (Japanese Patent Application Laid-open No. 2005-336477, and KIKUCHI Hirotsugu, Advanced Materials, Vol. 17, pp. 96-98, 2005). In this isotropic liquid crystal, orientation of the liquid crystal molecules is optically isotropic when no voltage is applied thereto, and accordingly, it is said that orientation films and orientation treatment, which have been required for the existing liquid crystal display apparatus using the nematic liquid crystal material, are generally unnecessary. Further, this isotropic liquid crystal has property that optically uniaxial anisotropy is induced in a voltage application direction only when a voltage is applied thereto, and has a feature that, in a state where no voltage is applied thereto, such optical anisotropy as in the nematic liquid crystal material does not exist, and the light scattering does not occur. As the isotropic liquid crystal as described above, there are known liquid crystal of a smectic blue phase or of a cubic phase, as well as liquid crystal of a cholesteric blue phase as described in Harry J. Coles, Nature, Vol. 436, pp. 997-1000, 2005. According to KIKUCHI Hirotsugu, Advanced Materials, Vol. 17, pp. 96-98, 2005, it is argued that, among them, such a liquid crystal material in which the cholesteric blue phase is polymer-stabilized makes the electro-optical response at higher speed than the nematic liquid crystal material.

According to with Japanese Patent Application Laid-open No. 2005-336477 and KIKUCHI Hirotsugu, Advanced Materials, Vol. 17, pp. 96-98, 2005, a liquid crystal display apparatus using the isotropic liquid crystal as described above is composed by using, similarly to the IPS mode, a comb tooth electrode for applying an in-plane electric field (hereinafter, a lateral electric field) to substrates, and by sandwiching the polymer-stabilized blue phase liquid crystal material between the substrates.

In each of these liquid crystal display apparatuses, the orientation films and the orientation treatment are unnecessary as mentioned above. Meanwhile, as disclosed in Japanese Patent Application Laid-open Nos. 2005-227759 and 2005-215339, a liquid crystal display apparatus, which is coated with the orientation films and subjected to orientation treatment for the purpose of improving the contrast, has also been proposed.

### SUMMARY OF THE INVENTION

The inventor of the present invention fabricated and evaluated a liquid crystal display apparatus based on Japanese Patent Application Laid-open No. 2005-336477 and KIKUCHI Hirotsugu, Advanced Materials, Vol. 17, pp. 96-98, 2005 and a liquid crystal display apparatus based on Japanese Patent Application Laid-open Nos. 2005-227759 and 2005-215339. As a result, the inventor has newly found an effect that the electro-optical response is accelerated in the liquid crystal display apparatus, in which the orientation films are coated on the substrates, and the optically isotropic liquid crystal material subjected to the orientation treatment is used.

However, in the case where the liquid crystal display apparatus using the optically isotropic liquid crystal material (blue phase liquid crystal material in particular) is coated with the orientation films and subjected to the orientation treatment, unevenness in color sometimes occurs when the liquid crystal display apparatus is allowed to display black in a state where no voltage is applied thereto. To be specific, such unevenness in color is prone to occur on the peripheries of a seal and spacers, and the like.

It is an object of the present invention to improve display characteristics in a display region while further accelerating the electro-optical response in the liquid crystal display apparatus using the optically isotropic liquid crystal material.

(1) A liquid crystal display apparatus according to the present invention includes: a pair of substrates; a medium which is sandwiched between the pair of substrates, is optically isotropic when no voltage is applied thereto, and exhibits optical anisotropy when a voltage is applied thereto; a pixel electrode and a common electrode which are formed on one of the pair of substrates, at least one of the pixel electrode and the common electrode being formed into a comb tooth shape; and a horizontal orientation film which is subjected to orientation treatment so as to orient the medium in a direction horizontal to the pair of substrates, and is formed on an interface of at least one of the pair of substrates with the medium, and the medium has a selective reflection peak derived from a (110) plane at 400 nm or less.

(2) The liquid crystal display apparatus according to (1), wherein the horizontal orientation film is subjected to the orientation treatment by photo-orientation.

(3) The liquid crystal display apparatus according to (1), wherein the horizontal orientation film is subjected to the orientation treatment by rubbing treatment.

(4) The liquid crystal display apparatus according to (1), wherein the horizontal orientation films are formed on the interfaces of both of the pair of substrates with the medium, and wherein a direction in which the medium is oriented by the horizontal orientation film formed on one of the pair of substrates and a direction in which the medium is oriented by the horizontal orientation film formed on another of the pair of substrates are parallel to each other.

(5) The liquid crystal display apparatus according to (1), wherein the pixel electrode and the common electrode generate, in the medium, a lateral electric field in a predetermined direction in-plane horizontal to the pair of substrates, and wherein a direction in which the medium is oriented by the horizontal orientation film and the predetermined direction in which the lateral electric field is generated make an angle smaller than 45 degrees.

(6) The liquid crystal display apparatus according to (1), wherein the pixel electrode and the common electrode generate, in the medium, a lateral electric field in a predetermined direction in-plane horizontal to the pair of substrates, and wherein a direction in which the medium is oriented by the horizontal orientation film and the predetermined direction in which the lateral electric field is generated make an angle smaller than 10 degrees.

(7) The liquid crystal display apparatus according to (1), wherein the medium comprises blue phase liquid crystal that exhibits a blue phase in a display temperature range.

According to the present invention, in the liquid crystal display apparatus using the optically isotropic liquid crystal, the display characteristics in the liquid crystal display panel can be improved while further accelerating the electro-optical response. Objects, configurations, and effects other than those described above become obvious from the following description of embodiments.

### BRIEF DESCRIPTION OF THE DRAWINGS

In the accompanying drawings:

FIG. 1 is a view illustrating a planar structure of a pixel of a liquid crystal display apparatus in each of Examples 1 to 3 and Comparative Examples 1 to 3;

FIG. 2 is a cross-sectional view illustrating a pixel structure of the liquid crystal display apparatus in each of Examples 1 to 3 and Comparative Examples 1 to 3;

FIG. 3 is a graph illustrating a reflection spectrum of a blue phase liquid crystal material for use in the liquid crystal display apparatus in Example 1;

FIG. 4 is a graph in which response times in the liquid crystal display apparatuses according to Example 1 and Comparative Examples 1 and 2 are compared with one another;

FIG. 5 is a graph illustrating reflection spectra of a blue phase liquid crystal material for use in the liquid crystal display apparatus according to Comparative Example 3;

FIG. 6 is a microscope photograph showing an orientation state of liquid crystal of a pixel portion in the liquid crystal display apparatus according to Comparative Example 3;

FIG. 7 is a microscope photograph showing an orientation state of liquid crystal in a vicinity of a sealing agent in the liquid crystal display apparatus according to Comparative Example 3;

FIG. 8 is a microscope photograph showing an orientation state of liquid crystal in a vicinity of a sealing agent in the liquid crystal display apparatus in Example 1;

FIG. 9 is a graph illustrating a relationship between a drive voltage in the liquid crystal display apparatus in Example 3 and an angle θ made by a liquid crystal orientation direction and an electric line of force;

FIG. 10 is a cross-sectional view illustrating a pixel structure of a liquid crystal display apparatus according to Example 4; and

FIG. 11 is a view illustrating a planar structure of a pixel of a liquid crystal display apparatus according to Example 5.

### DETAILED DESCRIPTION OF THE INVENTION

A liquid crystal display apparatus according to an embodiment of the present invention includes: a pair of substrates; a medium which is sandwiched between the pair of substrates, is optically isotropic when no voltage is applied thereto, and exhibits optical anisotropy when a voltage is applied thereto; a pixel electrode and a common electrode which are formed on one of the pair of substrates, at least one of the pixel electrode and the common electrode being formed into a comb tooth shape; and a horizontal orientation film which is subjected to orientation treatment so as to orient the medium in a direction horizontal to the pair of substrates, and is formed on an interface of at least one of the pair of substrates with the medium, and the medium has a selective reflection peak derived from a (110) plane at 400 nm or less.

Here, a drive principle of the liquid crystal display apparatus according to this embodiment is to generate an electric field between the pixel electrode and the common electrode, which are arranged on the one of the substrates sandwiching the optically isotropic medium, in particular, isotropic liquid crystal, and to control optical characteristics of such isotropic liquid crystal layer by changing intensity of the electric field. The isotropic liquid crystal has a feature of being optically isotropic when no voltage is applied thereto and inducing birefringence in a voltage application direction by being applied with a voltage. Therefore, the liquid crystal display apparatus according to this embodiment is normally black.

Owing to this property, in order to control transmittance of the isotropic liquid crystal, it is necessary to arrange upper and lower polarization plates in a crossed Nicols relationship, and to apply an electric field in an in-plane direction (lateral direction) of a liquid crystal panel. Hence, in the liquid crystal panel using the isotropic liquid crystal, an electrode structure of the IPS mode is basically suitable. Specifically, an electrode structure is basically suitable, in which both of the pixel electrode and the common electrode are arranged on one substrate, and at least one of the pixel electrode and the common electrode is formed into a comb tooth shape.

In the liquid crystal panel using the isotropic liquid crystal, the electrode structure of the IPS mode is basically suitable. However, any structure may be adopted as long as a component of an electric line of force (electric field) parallel to a substrate surface is generated between the electrodes or on the electrodes. For example, such a configuration maybe adopted, in which the pixel electrode and the common electrode are formed on the pair of substrates, respectively, and an oblique electric line of force is generated between the substrates.

Further, the horizontal orientation film of the liquid crystal display apparatus according to this embodiment may be any orientation film for use in a general liquid crystal display apparatus of the IPS mode, and a material thereof is not limited as long as the orientation film has a low pre-tilt angle.

Further, for the liquid crystal display apparatus according to this embodiment, a blue phase liquid crystal material serving as the isotropic liquid crystal is used, in which a selective reflection is present at 400 nm or less, and is not present at a wavelength larger than 400 nm. Therefore, a peak of a reflection spectrum that is observed at the longest wavelength and derived from the (110) plane is located in the ultraviolet region. Further, the orientation of the blue phase liquid crystal material is aligned by using the horizontal orientation film. In such a way, in the pixel region where the orientation is likely to be aligned, the peak of the reflection spectrum by the (110) plane appears substantially uniformly. However, in the regions near the seal, the spacers and the like, where the orientation is prone to be disturbed, peaks of reflection spectra by the (110) plane and the (200) plane appear, and mosaic-like (platelet-like) unevenness in color is prone to occur. In the liquid crystal display apparatus of this embodiment, the selective reflection derived from the (110) plane is present at 400 nm or less, and accordingly, the occurrence of unevenness in color is suppressed. Further, the horizontal orientation film is formed, whereby a response time from a voltage application state to a voltage non-application state is reduced, and moving picture quality of the liquid crystal display apparatus is enhanced.

Further, in the liquid crystal display apparatus according to this embodiment, the horizontal orientation film formed on the substrate is subjected to the orientation treatment by photo-orientation. A photo-orientation film and a non-contact orientation method by the photo-orientation method are used, whereby a good orientation state can be realized without being affected by a scratch, step or irregularities of the surface of the orientation film. Accordingly, also in the pixel region, the mosaic-like unevenness in color by the peaks of the reflection spectra from the (110) plane and the (200) plane becomes far less likely to occur.

Alternatively, the horizontal orientation film formed on the substrate may be subjected to the orientation treatment by rubbing treatment. An orientation method by the rubbing method is used, whereby the good orientation state can be realized even on a wide area. Accordingly, in the pixel region, the mosaic-like unevenness in color by the (110) plane and the (200) plane becomes less likely to occur.

Further, in the liquid crystal display apparatus according to this embodiment, in the case where the horizontal orientation films are formed on the interfaces of both of the pair of substrates with a medium as the optically isotropic liquid crystal material, a direction in which the liquid crystal is oriented by the horizontal orientation film formed on one of the pair of substrates and a direction in which the liquid crystal is oriented by the horizontal orientation film formed on the other of the pair of substrates may be made parallel to each other. With such a configuration, in the case of using the isotropic liquid crystal, in particular, the blue phase liquid crystal material, the mosaic-like unevenness in color by the (110) plane and the (200) plane becomes less likely to occur in the pixel region.

Further, in the liquid crystal display apparatus according to this embodiment, it is desired that an angle e made by the direction in which the liquid crystal is oriented by the horizontal orientation film and a direction in which the lateral electric field is generated by the pixel electrode and the common electrode (direction in which the electric line of force parallel to the substrate surface is generated) satisfy −45°≦θ≦45°. It is further preferred to set the angle θ as: −10°≦θ≦10°.

A drive voltage for driving the blue phase liquid crystal material sandwiched in the liquid crystal display apparatus has dependency on the angle e made by the direction of the electric field applied to the blue phase liquid crystal material serving as the isotropic liquid crystal and the orientation direction (rubbing direction) of the orientation film in the liquid crystal display apparatus in which the blue phase liquid crystal material is sandwiched. As the angle e becomes smaller, the drive voltage becomes lower. Hence, the drive voltage is lowered by adopting such a condition.

Further, the liquid crystal display apparatus according to this embodiment uses the medium that exhibits the blue phase in a display temperature range. In such a way, the response of the liquid crystal display apparatus can be accelerated effectively. It should be understood that it is possible to appropriately alter the present invention without departing from the technical idea in the embodiment described above and examples to be described below.

A specific description is made below of examples of the liquid crystal display apparatus according to the present invention.

### [Example 1]

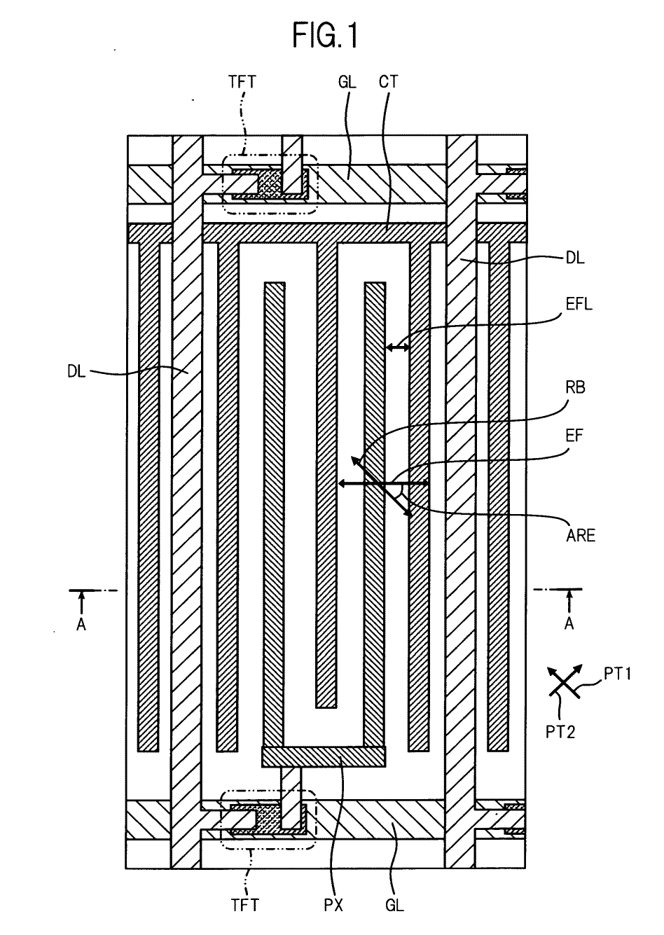

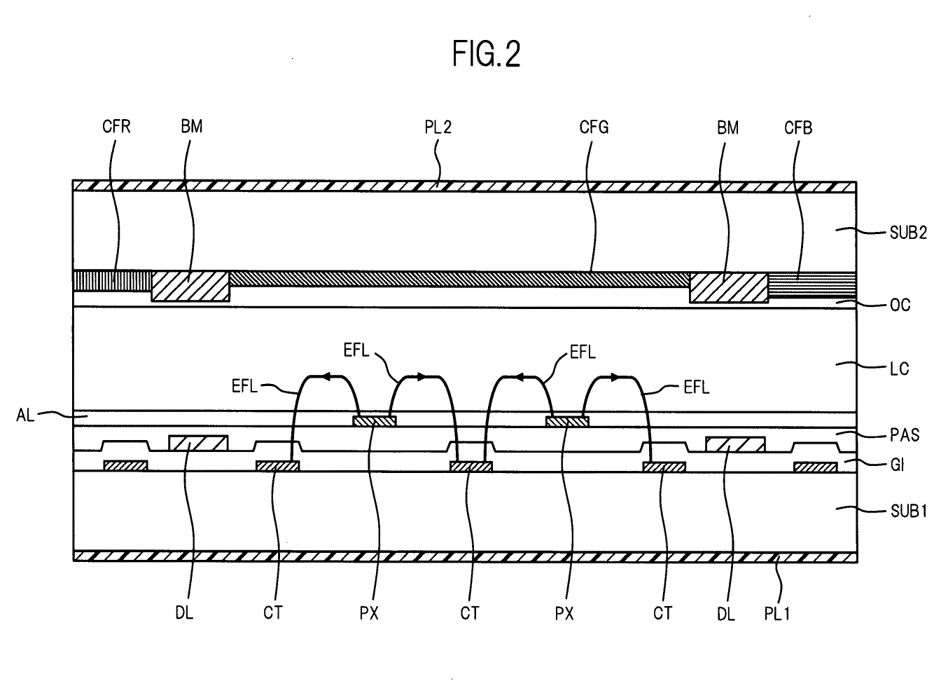

FIGS. 1 and 2 are views illustrating a device structure of a liquid crystal display apparatus in Example 1.

FIG. 1 is a view schematically illustrating a structure of a pixel. A video signal of a video signal line DL is supplied to a pixel electrode PX through a thin film transistor TFT controlled by a gate signal line GL. An electric field is formed between the pixel electrode PX and a common electrode CT to drive an isotropic liquid crystal layer LC, to thereby perform display.

FIG. 2 illustrates a cross-sectional view taken along the line A-A of FIG. 1. A black matrix BM is arranged on an upper substrate SUB2 including a color filter CFR, a color filter CFG, and a color filter CFB (hereinafter, these filters are referred to as color filters CF), to thereby prevent unnecessary light leakage. Further, with regard to the color filters CF, in order to emit light of different colors from pixels adjacent to one another in a direction in which the gate signal line GL is extended, the color filters of mutually different colors are adjacent to one another in the direction concerned. An overcoat film OC for planarization is coated on the color filters CF and the black matrix BM.

Meanwhile, in each of the pixels, a lower substrate SUB1 includes the common electrode CT and the pixel electrode PX, which are formed into comb tooth shapes. An insulating film GI is provided between the common electrode CT and the pixel electrode PX, and the video signal line DL is provided so as to correspond to a space between the common electrodes CT of the pixels adjacent to each other. Further, a protection film PAS is provided on the video signal line concerned, and the pixel electrode PX is arranged on the protection film PAS. Each of the common electrode CT and the pixel electrode PX is formed, for example, of such a transparent electrode made of indium tin oxide (ITO), or of such a metal electrode made of aluminum or a chromium alloy. Further, an orientation film AL is formed on the pixel electrode PX. In this embodiment, the orientation film AL is formed on an interface of the substrate SUB1 with the optically isotropic liquid crystal layer LC. In FIG. 2, the common electrode CT and the pixel electrode PX are formed in layers different from each other. However, it is also possible to form the common electrode CT and the pixel electrode PX in the same layer, for example, by forming a through hole that penetrates the insulating film GI and the protection film PAS.

Further, a pair of the substrates SUB1 and SUB2 include polarization plates PL1 and PL2, respectively, and transmission axes PT1 and PT2 of the polarization plates PL1 and PL2 are arranged so as to have a crossed Nicols relationship therebetween. At this time, the polarization plates PL1 and PL2 are arranged so that the transmission axis PT1 and the transmission axis PT2 can be orthogonal to each other as illustrated in FIG. 1 for an electric line of force EFL formed between the common electrode CT and the pixel electrode PX when a potential is generated in the pixel electrode PX. Specifically, in this example, the transmission axes PT1 and PT2 are provided so as to be inclined at 45 degrees with respect to the pixels arranged in matrix. The pixel electrode PX and the common electrode CT, which are formed into the comb tooth shapes, are formed so that a direction of the comb teeth can extend parallel to the video signal line DL, with the result that a lateral electric field generated by the pixel electrode PX and the common electrode CT is applied in a direction perpendicular to the comb teeth.

With such a configuration, during no application of a voltage, black display is made because the isotropic liquid crystal layer is isotropic. Meanwhile, during application of the voltage, white display is made because birefringence in a voltage application direction is induced in parallel to a panel surface, between the common electrode CT and the pixel electrode PX and on the common electrode.

Note that, in this example, with regard to the structures of the electrodes formed on a glass substrate, as illustrated in FIG. 1, both of the pixel electrode PX and the common electrode CT have the comb tooth shapes when observed from above a substrate surface. In FIG. 2, a film thickness of any one of the common electrode CT and the pixel electrode PX may be thicker than the other thereof. Alternatively, any one of those electrodes may be formed into a tabular shape.

Subsequently, a description is made of a manufacturing method for the liquid crystal display apparatus according to this example. However, the manufacturing method does not relate greatly to the present invention, and accordingly, specific details of the manufacturing method are omitted, and schematic procedure and configuration thereof are described.

First, the thin film transistor TFT and wiring electrodes SL and GL were formed on the substrate SUB1 as one of the pair of substrates.

In a display region of the pixel, on the substrate SUB1, the common electrode CT was formed as a transparent conductive layer made of indium tin oxide (ITO) into the comb tooth shape. On the common electrode CT, the insulating film GI made of silicon nitride or an organic material was further formed. In this example, film thicknesses of the common electrode CT formed of ITO into the comb tooth shape and of the insulating film GI were set at 77 nm and 500 nm, respectively.

Next, as illustrated in FIG. 2, on the insulating film GI, the electrode PX with the comb tooth shape was formed as an ITO electrode layer with a film thickness of 77 nm. At this time, widths of the pixel electrode PX and the common electrode CT were each set at 5.0 μm, and a distance therebetween was set at 5.0 μm.

On the other substrate SUB2, the black matrix BM and the color filters CF were formed, and the overcoat layer OC was thereafter coated and fired thereon.

Further, on the interface of the substrate SUB1 with the optically isotropic liquid crystal layer LC, horizontally oriented polyamic acid varnish (AL16470 manufactured by JSR Corporation) for orientation films was coated by printing, followed by firing at 200° C., to thereby form the orientation film AL. For the orientation film in this case, a polyimide material is preferred, and any one of the following types may be used, which are: an orientation film material of a type called a polyamic acid type, from which a polyimide film is obtained in such a manner that the material concerned is heated and fired after being coated on the substrate; and an orientation film material of a type called a soluble polyimide type, which does not require performing the heating and the firing after the material concerned is coated on the substrate. Anyone of both described above may be used as long as the orientation film can be formed, which can horizontally orient a general nematic liquid crystal material with a low pre-tilt angle.

Further, the orientation film AL was subjected to rubbing treatment in a direction of 30 degrees with respect to a direction in which the electric line of force (lateral electric field) is generated. Orientation treatment at this time is not particularly limited as long as the nematic liquid crystal can be oriented horizontally.

Among those two substrates, on a peripheral portion of the substrate SUB1 on which the electrodes were formed, a sealing agent was formed. Onto a portion inside the sealing agent, in which the pixels were formed, the liquid crystal material was dropped, and then the substrate SUB2 on which the color filters CF were formed was stacked so as to be opposed thereto. At this time, a thickness (gap) of the liquid crystal layer LC as an optically isotropic medium was adjusted to be approximately 25.0 μm in a sealed state by spacers formed on the substrate SUB2. For this gap, the value thereof is not limited to the above because the optimal value just needs to be selected based on characteristics of the liquid crystal material and desired display characteristics.

Thereafter, a temperature was set so that the dropped liquid crystal material could turn to the blue phase in the entirety of the display region, and then, by using a high-pressure mercury-vapor lamp, an ultraviolet ray with a wavelength of 365 nm was applied in-plane uniformly from a back surface of the substrate SUB1 including such comb teeth-like pixel electrode PX and common electrode CT so that energy to be given thereto could become 1,800 mJ. The set temperature at this time was approximately 21.2° C.

For the liquid crystal material used here, such a liquid crystal material was selected, in which, among selective reflections of the blue phase, a reflection that was derived from the (110) plane and appeared at the longest wavelength could become 400 nm or less. In this example, KIKUCHI Hirotsugu, IDW/AD '05, pp. 21-24, 2005 was referred to, and the material described in p. 24 was prepared and used. Ratios of components of this material were set as: 37.2 mol % for JC1041-XX (manufactured by Chisso Corporation); 37.2 mol % for 5CB (manufactured by Sigma-Aldrich Corporation); 5.6 mol % for ZLI4572 (manufactured by Merck & Co., Inc.); and 20 mol % for CB15 (manufactured by DKSH Management Ltd.). Further, a liquid crystal monomer RM257 and an acrylic monomer EHA were added by amounts described in the document concerned.

Note that, according to KIKUCHI Hirotsugu, IDW/AD '05, pp. 21-24, 2005, the selective reflections of the blue phase depend on an amount of a chiral agent contained in the liquid crystal, and are reduced in wavelength as the amount of the chiral agent is larger. From this fact, in this example, 5.6 mol % of ZLI572 (manufactured by Merck & Co., Inc.) and 20 mol % of CB15 (manufactured by DKSH Management Ltd.) were contained as such chiral agents. However, the chiral agents may be added more than in this example as long as the chiral agents are not precipitated at low temperature and the selective reflection that appears at the longest wavelength is 400 nm or less. Further, the chiral agents are not limited to ZLI4572 and CB15 as long as both of chiral power (HTP) and solubility are large.

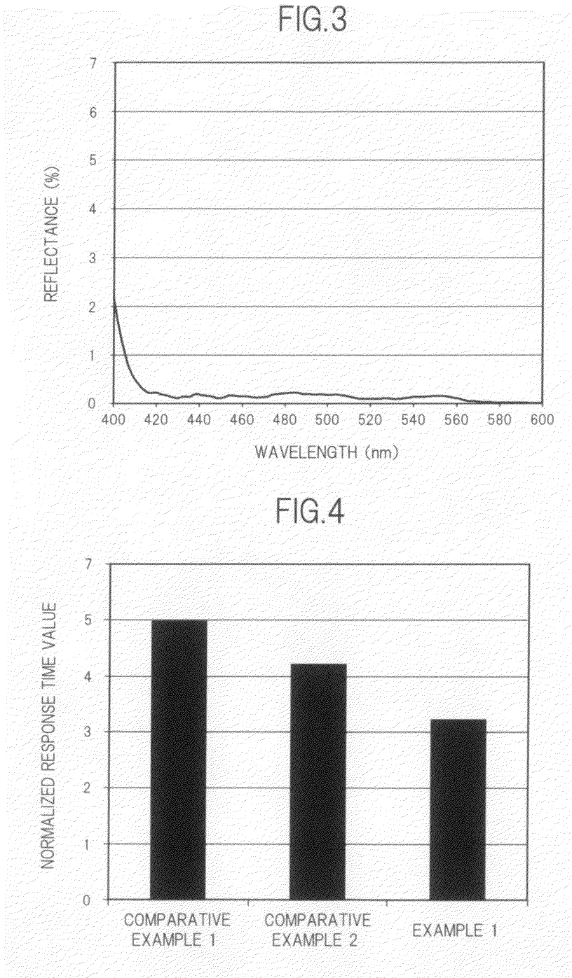

Here, FIG. 3 illustrates a reflection spectrum of the above-mentioned blue phase liquid crystal material, which was used in this example, after being irradiated with the ultraviolet ray. As illustrated in this graph, a selective reflection peak derived from the (110) plane was approximately 380 nm, and it was confirmed that the selective reflection peak of the liquid crystal material used in this example was 400 nm or less. Further, it was confirmed that the blue phase appeared in a display temperature range of the liquid crystal display apparatus.

Next, this panel was sandwiched between the two polarization plates PL1 and PL2 (SEG1224DU manufactured by Nitto Denko Corporation), and the polarization plates PL1 and PL2 were arranged so that polarization transmission axes thereof could be orthogonal to each other. As illustrated in FIG. 1, angles made by directions of the transmission axes PT1 and PT2 of the polarization plates PL1 and PL2 were individually set at 45 degrees with respect to an in-plane direction of the electric line of force EFL.

Next, a drive circuit was connected to the assembled panel and polarization plates so that an alternating current drive voltage ACV could be applied to the above-mentioned comb teeth-like common electrode CT and pixel electrode PX, and thereafter, a backlight and the like were connected to the panel and the polarization plates to thereby make a module and obtain the display apparatus.

### [Comparative Example 1]

A liquid crystal display apparatus similar to the liquid crystal display apparatus according to Example 1 except that the orientation film AL was not coated was fabricated as a liquid crystal display apparatus of Comparative Example 1.

### [Comparative Example 2]

A liquid crystal display apparatus similar to the liquid crystal display apparatus according to Example 1 except that the rubbing treatment was not implemented after the orientation film AL was coated was fabricated as a liquid crystal display apparatus of Comparative Example 2.

FIG. 4 illustrates a response time in each of Example 1, Comparative Example 1, and Comparative Example 2. Normalized response time values on an axis of ordinates of FIG. 4 were illustrated by taking, as a reference, a falling response time (response time required for a change from a voltage application state to a voltage non-application state) in the response time in the liquid crystal display apparatus fabricated in accordance with Comparative Example 1. As a result, in the liquid crystal display apparatus in which the orientation film AL was coated but the orientation treatment was not implemented as in Comparative Example 2, it was found out that the response time thereof became smaller than in Comparative Example 1 in which the orientation film AL was not coated. Further, in the liquid crystal display apparatus in Example 1, it was found out that the response time thereof became much smaller (improved) than in Comparative Example 2.

As in the liquid crystal display apparatus of Example 1, the orientation film AL as a horizontal orientation film was coated. In such a way, in the liquid crystal display apparatus using the isotropic liquid crystal, the improvement of the response time can be achieved, and an effect thereof is further enhanced by further implementing the orientation treatment.

### [Comparative Example 3]

For a liquid crystal display apparatus according to Comparative Example 3, a material described in p. 24 of KIKUCHI Hirotsugu, IDW/AD '05, pp. 21-24, 2005 was used in place of the liquid crystal material used in the liquid crystal display apparatus according to Example 1. Component ratios of the liquid crystal material at this time were set as 47.8 mol % for JC1041-XX (manufactured by Chisso Corporation), 47.8 mol % for 5CB (manufactured by Sigma-Aldrich Corporation), and 4.4 mol % for ZLI4572 (manufactured by Merck & Co., Inc.). Further, the liquid crystal monomer RM257 and the acrylic monomer EHA were added by amounts described in the document concerned. A liquid crystal material obtained in the above-described manner was used. The selective reflection peak, which appeared on the longest wavelength side at this time, was approximately 530 nm.

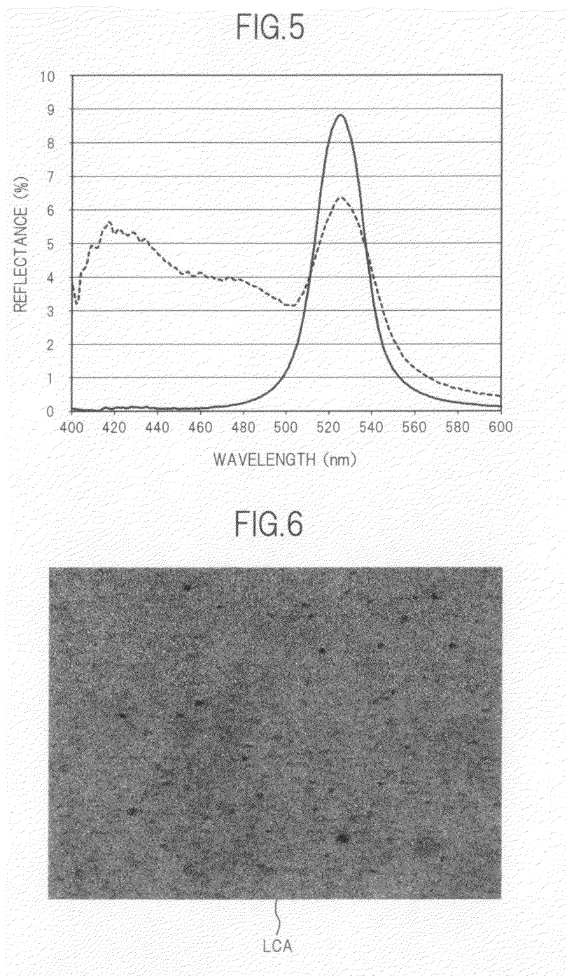

FIG. 5 illustrates reflection spectra in a pixel portion and a vicinity of a sealing agent. Here, a solid line indicates the reflection spectrum in the pixel portion, and a broken line indicates the reflection spectrum in the vicinity of the sealing agent. Further, FIGS. 6 and 7 show results of microscope observation for the pixel portion and the vicinity of the sealing agent, respectively, at the time when no voltage is applied to pixels in almost all the display region of the liquid crystal display apparatus according to Comparative Example 3 to make the black display. A uniform blue phase was formed in a liquid crystal layer LCA of the pixel portion, but in a liquid crystal layer LCB in the vicinity of the sealing agent, platelet-like textures appeared in the result of the microscope observation.

As mentioned above, in the liquid crystal display apparatus in Comparative Example 3, the platelet-like textures of verdigris color and dark blue color were formed in the vicinity of the sealing agent, and a blue phase of the verdigris color was uniformly formed in the pixel portion. Accordingly, when the entirety of the liquid crystal display apparatus was viewed, unevenness in color was observed between the periphery of the sealing agent and the pixel portion. Further, as in the periphery of the sealing agent, also in the vicinities of the spacers, the unevenness in color was observed. The reason for this is considered to be that, in the optically isotropic liquid crystal material subjected to horizontal orientation treatment by the orientation film AL as the horizontal orientation film, both of the platelet-like textures derived from the (110) plane and the (200) plane appear in the periphery of the sealing agent and the vicinities of the spacers. It is thus considered that, in the case where the black display is made in the voltage non-application state, light generated by the reflection peak spectrum of the optically isotropic liquid crystal material is observed as different color tones between the pixel portion, and the periphery of the sealing agent and the vicinities of the spacers by a viewer of the liquid crystal display apparatus, resulting in the unevenness in color.

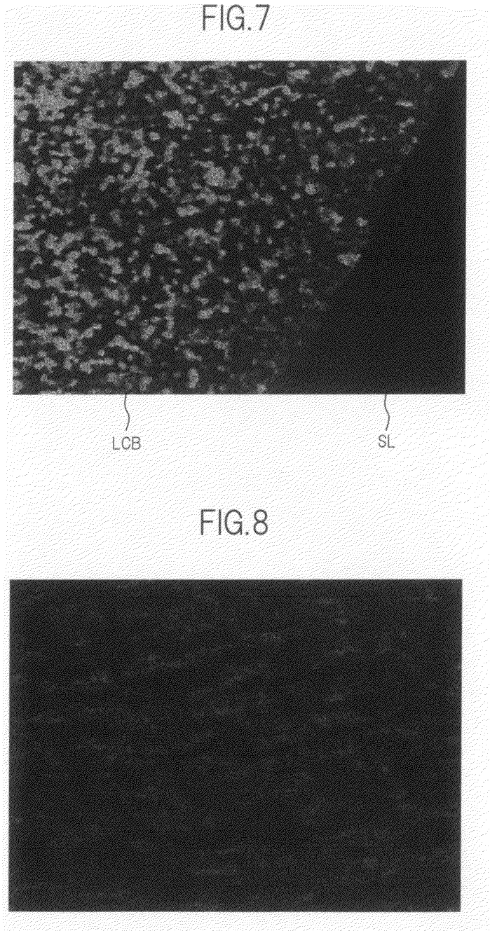

Meanwhile, in the liquid crystal display apparatus in Example 1, among the selective reflections of the used liquid crystal material, the reflection peak that appeared at the longest wavelength was 400 nm or less. Accordingly, at the time when no voltage was applied to the pixels in almost all the display region to make the black display, the platelet-like textures were hardly able to be visually confirmed also in the vicinity of the sealing agent (FIG. 8).

As described above, as in the liquid crystal display apparatus according to Example 1, the isotropic liquid crystal is used, and the orientation film AL is further coated, to thereby improve the response time. At the same time, the reflection peak that appears at the longest wavelength among the selective reflections of the liquid crystal material is set at 400 nm or less. In such a way, the unevenness in color in the vicinities of the sealing agent and the spacers and in the pixel portion can be reduced.

### [Example 2]

In Example 2, in place of the orientation film AL16470 used in Example 1, photoreactive polyimide and polyamide acid ester were used with reference to Japanese Patent Application Laid-open No. 2009-75569, and were further subjected to photo-orientation treatment. At this time, the photoreactive polyimide and polyamide acid ester were subjected to the photo-orientation treatment by being irradiated with a polarized ultraviolet ray so that an orientation direction of the liquid crystal can become a direction of 0 degrees with respect to the direction in which the electric line of force (lateral electric field) is generated. In general, in the treatment by the rubbing method, it is considered highly possible that the orientation treatment may be insufficient in end portions of the electrodes and the spacers. From this fact, it is considered possible that the blue phase may not be uniformly formed depending on the structure of the pixel.

However, as in this example, if the photoreactive materials are coated on the substrates, and the photo-orientation treatment of implementing the orientation treatment by the irradiation of the ultraviolet ray is performed, then such a possibility as described above is reduced, which is desirable. In the liquid crystal display apparatus of this example, it was confirmed that the blue phase liquid crystal was substantially uniformly formed, and that display quality was enhanced by using the orientation film with photo-orientation properties.

Note that materials of the orientation film with the photo-orientation properties are not limited to the materials used in this example, and materials may be used, which horizontally orient the liquid crystal by ultraviolet irradiation such as polarized or unpolarized oblique irradiation. For example, such materials include azobenzene and derivatives thereof, or cinnamoyl, coumarin, and benzylidenephthalimidine.

### [Example 3]

In order to examine an influence given to the display characteristics by the orientation direction of the orientation film AL formed on the substrate SUB1 in the liquid crystal display apparatus of Example 1, a liquid crystal display apparatus according to Example 3 was fabricated. This liquid crystal display apparatus was subjected to the rubbing treatment so that an angle ARE made by a direction EF in which the electric line of force EFL (lateral electric field) was generated and a rubbing direction RB (liquid crystal orientation direction) could become 0, 30, 45, 60, and 90 degrees. Except for such a point, the liquid crystal display apparatus of Example 3 is similar to the liquid crystal display apparatus of Example 1.

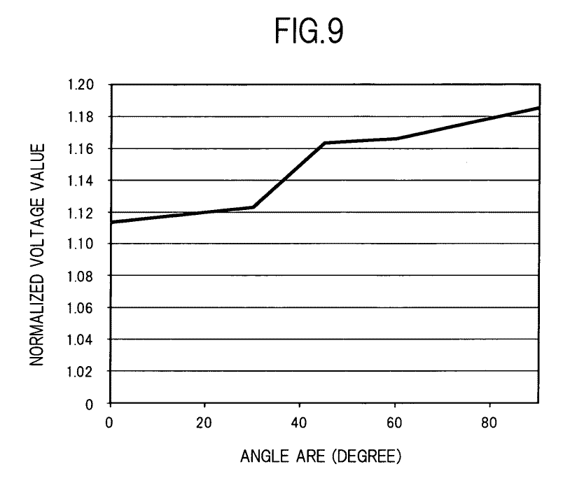

FIG. 9 illustrates a dependency of the drive voltage on the angle ARE. Normalized voltage values on an axis of ordinates of FIG. 9 were given by taking, as a reference, the drive voltage in the liquid crystal display apparatus according to Comparative Example 1. From FIG. 9, it is grasped that, in the liquid crystal display apparatus according to Example 3, the drive voltage was increased more than in the liquid crystal display apparatus according to Comparative Example 1. Further, in accordance with the examination at this time, it is desired that the angle ARE be small. In particular, in the case where the angle ARE is 45 degrees or more, the increase in drive voltage is almost saturated, and accordingly, it is desired that the angle ARE be 45 degrees or less. Note that, in the case where the angle ARE is 10 degrees or less, the decrease in drive voltage is saturated, and accordingly, it is further desired that the angle ARE be 10 degrees or less.

Note that, even if the rubbing direction RB is axisymmetric to the direction EF of the electric line of force (that is, even if the angle ARE is 0 degrees or 90 degrees), a similar effect to that in FIG. 9 is obtained. Hence, when the angle ARE is θ, the drive voltage can be reduced effectively under a condition of −45°≦θ≦45°, more desirably −10°≦θ≦10°.

### [Example 4]

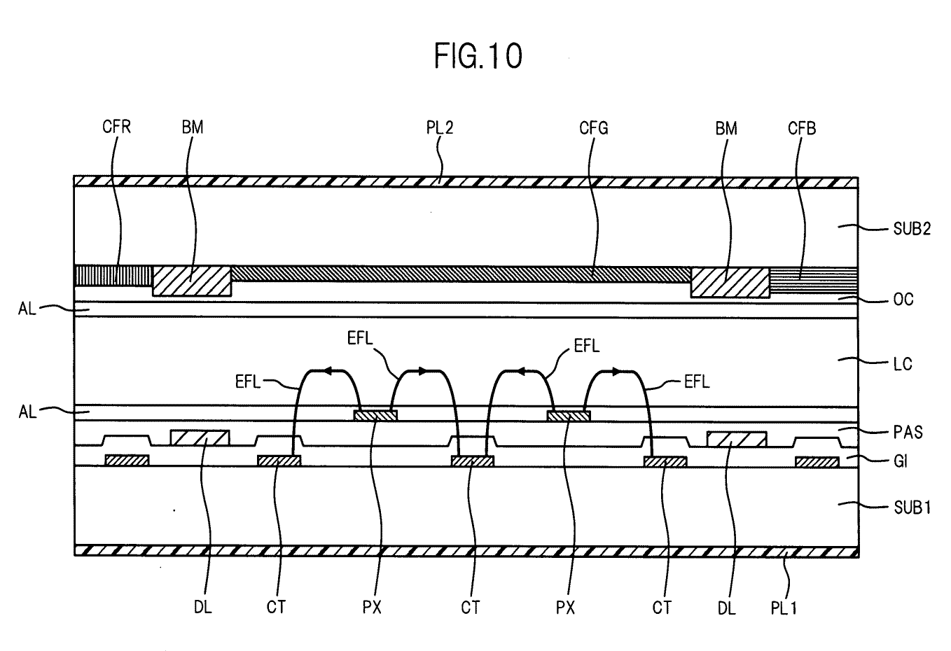

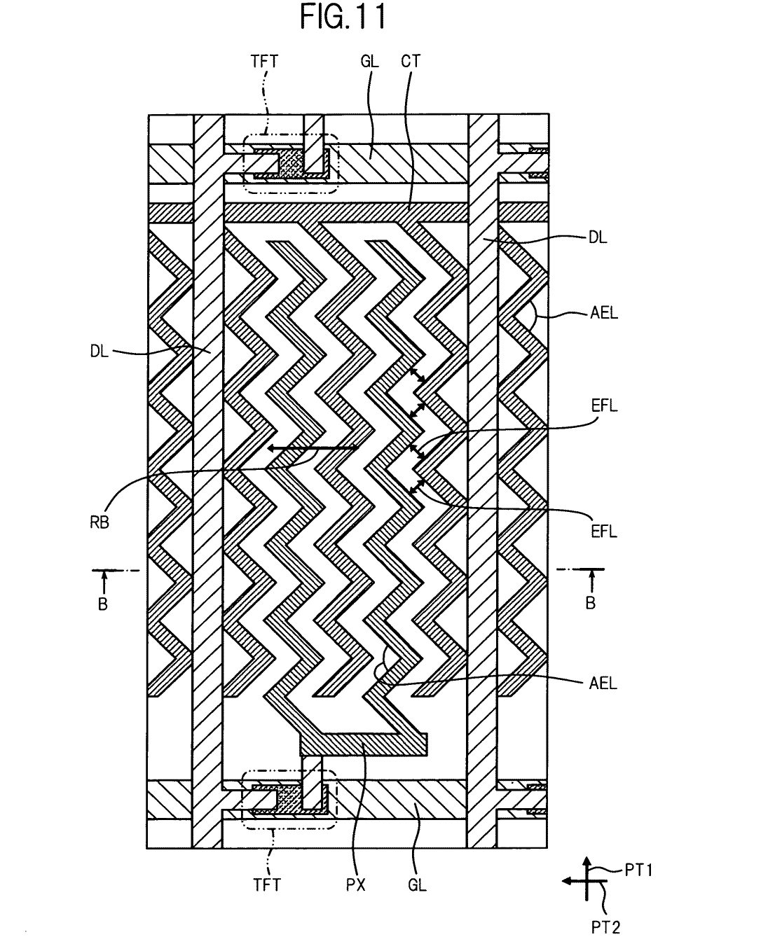

In Example 4, in a similar way to the liquid crystal display apparatus of Example 1, the black matrix BM and the color filters CF were formed on the substrate SUB2, and thereafter, the overcoat layer OC was coated and fired thereon. In addition, thereafter, another orientation film AL similar to the orientation film AL formed on the substrate SUB1 was also formed on the substrate SUB2, and further, the orientation film AL on the substrate SUB2 was also similarly subjected to the rubbing treatment in the direction of 30 degrees with respect to the direction in which the electric line of force (lateral electric field) was generated. In such a way, the orientation film AL on the substrate SUB1 and the orientation film AL on the substrate SUB2 were subjected to the rubbing treatment in the direction of 30 degrees with respect to the direction in which the electric line of force was generated, and were subjected to the rubbing treatment in directions parallel to each other. By a similar method to that of Example 1 except for such a point as described above, a liquid crystal display apparatus of Example 4 was fabricated. FIG. 10 is a view illustrating a cross-sectional structure of the liquid crystal display apparatus fabricated in Example 4.

In a similar way to the liquid crystal display apparatus according to Example 1, also in this example, in the liquid crystal display apparatus in which the isotropic liquid crystal is used and the orientation films AL are coated, the reflection peak that appears at the longest wavelength among the selective reflections of the liquid crystal material is set at 400 nm or less. In such a way, the unevenness in color between the pixel portion and the vicinities of the sealing agent and the spacers can be reduced, and the display quality of the liquid crystal display apparatus can be enhanced effectively.

### [Example 5]

FIG. 11 is a view schematically illustrating a structure of one pixel of a liquid crystal display apparatus according to Example 5. The structure of the pixel is similar to that of Example 1 except that the shapes of the pixel electrode PX and the common electrode CT are different, and a cross-sectional view taken along a line B-B is substantially similar to that of FIG. 2. Note that, at this time, angles of bend AEL of the pixel electrode PX and the common electrode CT are 90 degrees.

In accordance with the examination result in Example 3, it is desired that the angle θ made by the rubbing direction RB and the direction EF of the electric line of force (direction in which the lateral electric field is generated) satisfy −45°≦θ≦45°. In this example, two directions EF of the electric line of forces are generated, and are orthogonal to each other. In such a pixel structure, it is desired to set the rubbing direction so that the pixel electrode or the common electrode can make an angular relationship of −45°≦θ≦45° with respect to the bidirectional electric line of forces generated while being bent in the two different directions. In the liquid crystal display apparatus of Example 5, the rubbing direction RB of FIG. 11 is set as a horizontal direction thereof so that the angle ARE can become −45 degrees or 45 degrees.

As in this example, in the liquid crystal display apparatus in which the isotropic liquid crystal is used and the orientation film is coated, even if the electrode structure thereof is not linear, it becomes possible to reduce the drive voltage by setting the angle ARE at an appropriate value.

As described above, the improvement in display characteristics was achieved while allowing the high-speed response by using the liquid crystal material having the optical isotropy, in particular, the material that exhibits the blue phase in the display temperature range of the liquid crystal display apparatus. With all of the materials used in this example, it was possible to obtain good display characteristics at around room temperature. However, materials for use are not limited to those used in this example, and materials which exhibit the blue phase in a wider temperature range may be used. In consideration of actual use, materials are desired, which exhibit the blue phase in a display temperature range of the liquid crystal display apparatus from 0° C. or more, more desirably −20° C. or more to 70° C. or less, more desirably 100° C. or less. It is considered that use of the materials described above may contribute to reliability enhancement for the temperature of the liquid crystal display apparatus.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display apparatus comprising:
a pair of substrates;
a medium which is sandwiched between the pair of substrates, is optically isotropic when no voltage is applied thereto, and exhibits optical anisotropy when a voltage is applied thereto;
a pixel electrode and a common electrode which are formed on one of the pair of substrates,
at least one of the pixel electrode and the common electrode being formed into a comb tooth shape; and
a horizontal orientation film which is subjected to orientation treatment so as to orient the medium in a direction horizontal to the pair of substrates, and is formed on an interface of at least one of the pair of substrates with the medium,
wherein the medium has a selective reflection peak derived from a (110) plane at 400 nm or less.

2. The liquid crystal display apparatus according to claim 1,
wherein the horizontal orientation film is subjected to the orientation treatment by photo-orientation.

3. The liquid crystal display apparatus according to claim 1,
wherein the horizontal orientation film is subjected to the orientation treatment by rubbing treatment.

4. The liquid crystal display apparatus according to claim 1,
wherein the horizontal orientation films are formed on the interfaces of both of the pair of substrates with the medium, and
wherein a direction in which the medium is oriented by the horizontal orientation film formed on one of the pair of substrates and a direction in which the medium is oriented by the horizontal orientation film formed on another of the pair of substrates are parallel to each other.

5. The liquid crystal display apparatus according to claim 1,
wherein the pixel electrode and the common electrode generate, in the medium, a lateral electric field in a predetermined direction in-plane horizontal to the pair of substrates, and
wherein a direction in which the medium is oriented by the horizontal orientation film and the predetermined direction in which the lateral electric field is generated make an angle smaller than 45 degrees.

6. The liquid crystal display apparatus according to claim 1,
wherein the pixel electrode and the common electrode generate, in the medium, a lateral electric field in a predetermined direction in-plane horizontal to the pair of substrates, and
wherein a direction in which the medium is oriented by the horizontal orientation film and the predetermined direction in which the lateral electric field is generated make an angle smaller than 10 degrees.

7. The liquid crystal display apparatus according to claim 1,
wherein the medium comprises blue phase liquid crystal that exhibits a blue phase in a display temperature range.
